(19) United States
(12) Patent Application Publication
(10) Pub. No.: US 2004/0168534 A1
(43) Pub. Date: Sep. 2, 2004

(54) Idler bearing

(76) Inventor: Manfred Winkler, Herzogenaurach (DE)

Correspondence Address: MUSERLIAN AND LUCAS AND MERCANTI, LLP, 475 PARK AVENUE SOUTH, NEW YORK, NY, 10016, US

(21) Appl. No.: 10/484,831

(22) PCT Filed: Jul. 3, 2002
(86) PCT No.: PCT/EP02/07329

(51) Int. Cl. F16H 55/00

(52) U.S. Cl. 74/421 R; 74/431

(57) ABSTRACT

The invention concerns a gearwheel for a mechanical gearwheel transmission of an automotive vehicle, which gearwheel rotates loosely on a shaft, cylindrical rolling elements (18, 19) being arranged between an inner raceway associated to the shaft and an outer raceway associated to a hub of the gearwheel. According to the invention, the gearwheel (13) is mounted through two spaced apart roller crown rings comprising cylindrical rolling elements (18, 19) and cages (20, 25), projections (21, 26) of the cages (20, 25) engaging into a groove (22) that is arranged in a radially inward pointing center flange (24) between the outer raceways (17). In this way, an inseparable pre-assembled unit made up of the gearwheel (13) and the roller crown rings is formed that facilitates the assembly of the mechanical gearwheel transmission.

### FIELD OF THE INVENTION

The invention concerns a gearwheel for a mechanical gearwheel transmission of an automotive vehicle, which gearwheel rotates loosely on a shaft and can be coupled through a coupling element to the shaft, cylindrical rolling elements being arranged radially between an inner raceway associated to the shaft and an outer raceway associated to a hub of the gearwheel.

### BACKGROUND OF THE INVENTION

A mechanical gearwheel transmission of the pre-cited type for an automotive vehicle is described, for instance, in DE 197 13 304 A1. The gearwheel shown in FIG. 1 of this prior art is mounted on a transmission shaft through two spaced apart rows of cylindrical rolling elements that are lodged in a cage. A drawback of this prior art is that the mounting of the assembly made up of the gearwheel and the roller crown ring is rendered more difficult because the two parts are not retained on each other.

### OBJECT OF THE INVENTION

It is therefore an object of the invention to permit a pre-assembly of the roller crown rings in the gearwheel so as to reduce the total cost and work of mounting during the manufacture of the mechanical gearwheel transmission.

This and other objects and advantages of the invention will become obvious from the following detailed description.

### SUMMARY OF THE INVENTION

The invention achieves the above objects by the fact that the gearwheel is mounted through two spaced apart roller crown rings comprising cylindrical rolling elements and cages which comprise radially outward oriented projections that engage into a groove that is arranged between the outer raceways of the roller crown rings in a radially inward pointing center flange of the gearwheel.

In this way, an assembled unit made up of the gearwheel and the roller crown rings is formed whose parts are retained inseparably on each other. This has the advantage that the gearwheel and the roller crown rings can no longer fall apart during transportation and can be handled as a single unit during mounting. The projections can be made in the most different of manners; either as circumferentially equally spaced retaining lugs or as a continuous retaining ring.

According to one proposition of the invention, a particularly advantageous connection between the gearwheel and the roller crown rings is obtained if the projections of the cage are elastic. In this case, it has proved to be advantageous for achieving elasticity if the projection is connected to a radially inner clear space into which the project can deflect during snapping-in.

Finally, according to a further feature of the invention, the cage comprises a continuous longitudinal slit at one peripheral point. The result of this is that, during the rotation of the bearing, the rolling bearing cage widens under the centrifugal force acting thereon, so that the cage is supported either on the rolling elements or directly on the rolling element raceways thus bringing about an enhancement of the friction performance of the bearing. In this way, the phenomenon of idler gear screeching known to a person skilled in the art is effectively eliminated.

The objects of the invention are alternatively achieved by the fact that the gearwheel is mounted through a double-row roller crown ring comprising two spaced apart rows of cylindrical rolling elements and a single common cage, said cage comprising at least one radially outward oriented projection that engages into a groove arranged in the hub of the gearwheel.

The invention will now be described more closely with the help of examples of embodiment and with reference to the appended drawings.

### BRIEF DESCRIPTION OF THE DRAWING

FIG. 1 shows a longitudinal section through a prior art mechanical gearwheel transmission,

FIG. 2 shows an inventive arrangement of roller crown rings in a gearwheel, and

FIG. 3 shows another inventive arrangement of roller crown rings in a gearwheel.

### DETAILED DESCRIPTION OF THE DRAWING

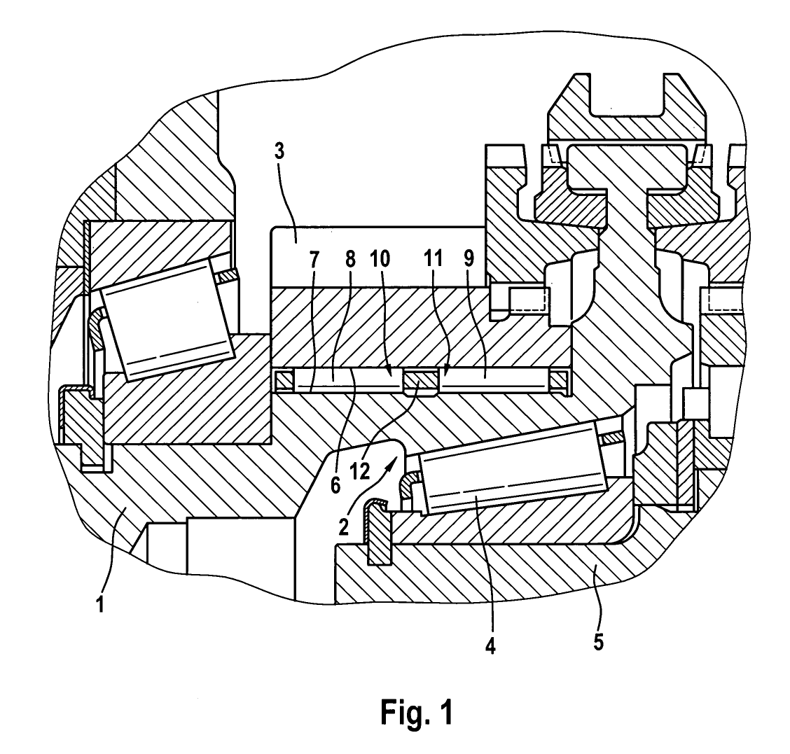

In the prior art shown in FIG. 1, the idler gear 3 comprising a toothing is mounted through the rolling bearing 2 on the secondary shaft 1. The main shaft 5 is mounted in the partly hollow secondary shaft 1 through the taper roller bearing 4. The idler gear 3 and the secondary shaft 1 form the raceways 6, 7 for the rolling elements 8, 9 that are configured as needle rollers and arranged next to each other in two rows or crown rings. The rolling elements 8, 9 are guided on the radially inner side in pockets 10, 11 of the cage 12. If one visualizes this synchronizing device in the dismounted state, it becomes clear that the roller crown ring made up of the two rows of needle rollers 8 and 9 and the cage 12 will slip out of the hub of the idler gear 3.

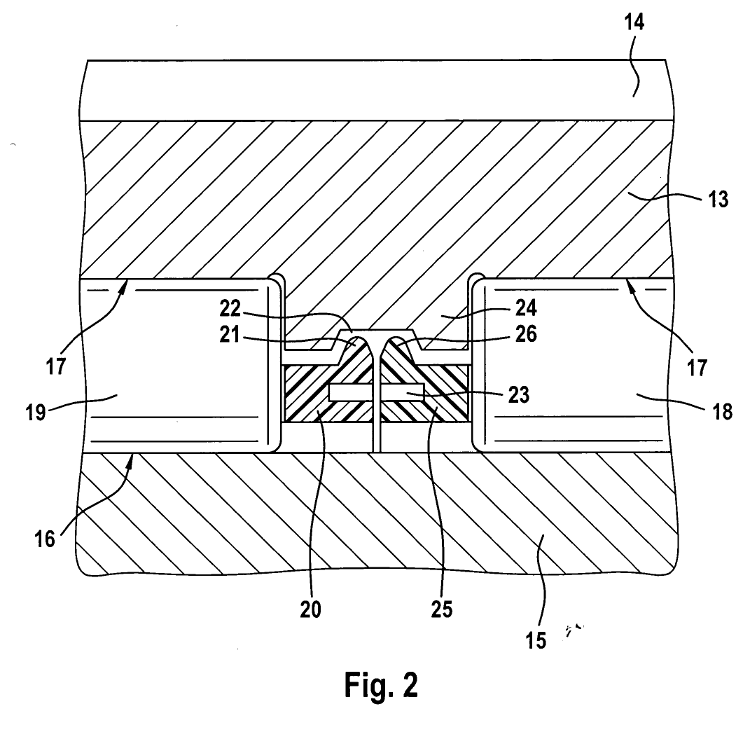

According to the invention shown in FIG. 2, the idler gear 13 in mounted on the shaft 15 through two spaced apart rows of cylindrical rolling elements 18, 19 in the form of needle rollers, each row being arranged in a cage 20, 25. The inner raceway 16 of the rolling elements 18, 19 is furnished by the outer peripheral surface of the shaft 15 and the outer raceway 17 by the hub of the idler gear 13. The idler gear 13 comprises the radially inwards pointing center flange 24 that is situated between the two outer raceways 17 and comprises the circumferential groove 22. The projections 21, 26 of the cages 20, 25 are snapped into this groove 22 and comprise the radially inner clear space 23 into which they can deflect when springing elastically into the groove 22. Thus, the coherence of the idler gear 13 and the needle roller crown rings made up of the rolling element rows 18, 19 and the cages 20, 25 is assured in an elegant manner.

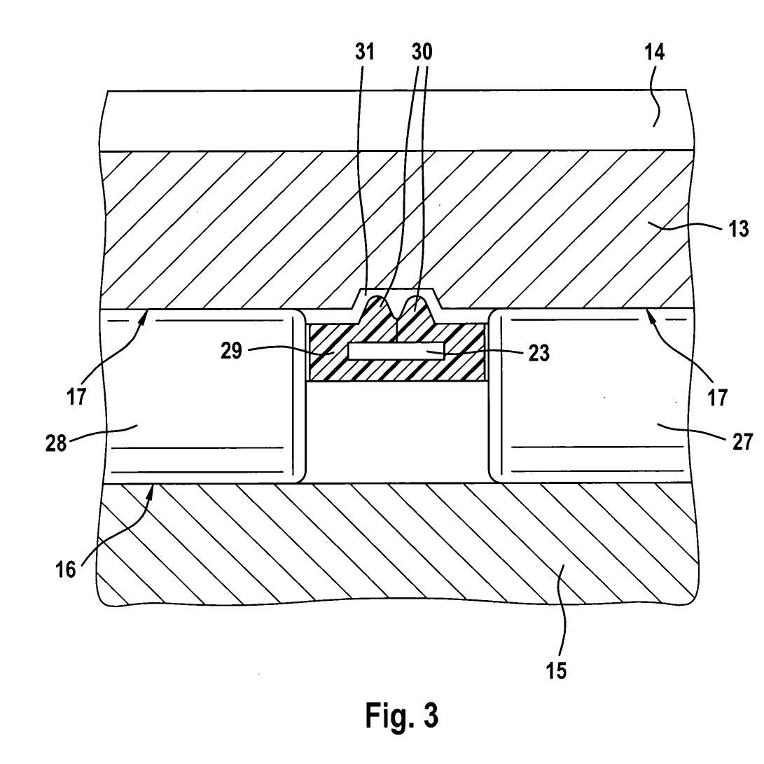

The idler gear 13 shown in FIG. 3 is mounted on the shaft 15 through the double row roller crown ring that is made up of two spaced apart cylindrical rolling element rows 27, 28 and the common cage 29. The cage 29 comprises radially outward extending elastic projections 30 which engage into the groove 31 that is arranged in the hub of the idler gear 13.

What is claimed is:

1. A gearwheel for a mechanical gearwheel transmission of an automotive vehicle, which gearwheel rotates loosely on a shaft and can be coupled through a coupling element to the shaft, cylindrical rolling elements being arranged radially between an inner raceway associated to the shaft and an outer raceway associated to a hub of the gearwheel, wherein the gearwheel is mounted through two spaced apart roller crown rings comprising cylindrical rolling elements and cages which comprise radially outward oriented projections that engage into a groove that is arranged between the outer raceways of the roller crown rings in a radially inward pointing center flange of the gearwheel.

2. An idler gear bearing of claim 1, wherein the projection of the cage is elastic.

3. An idler gear bearing of claim 2, wherein the projection is connected to a radially inner clear space.

4. An idler gear bearing of claim 1, wherein the cage comprises a continuous longitudinal slit at one peripheral point.

5. A gearwheel for a mechanical gearwheel transmission of an automotive vehicle, which gearwheel rotates loosely on a shaft and can be coupled through a coupling element to the shaft, cylindrical rolling elements being arranged radially between an inner raceway associated to the shaft and an outer raceway associated to a hub of the gearwheel, wherein the gearwheel is mounted through a double-row roller crown ring comprising two spaced apart rows of cylindrical rolling elements and a single common cage, said cage comprising at least one radially outward oriented projection that engages into a groove arranged in the hub of the gearwheel.
